(19) United States
(12) Patent Application Publication
(10) Pub. No.: US 2003/0113508 A1
(43) Pub. Date: Jun. 19, 2003

(54) Tablecloth and device for fixing the skirt of said tablecloth

(76) Inventor: Maria Jose Almansa Perba, El Escorial (ES)

Correspondence Address: WILLIAM COLLARD, COLLARD & ROE, P.C., 1077 NORTHERN BOULEVARD, ROSLYN, NY, 11576, US

(21) Appl. No.: 10/276,363

(22) PCT Filed: May 14, 2001
(86) PCT No.: PCT/ES01/00187

(30) Foreign Application Priority Data
May 17, 2000 (ES) U 0001306
May 17, 2000 (ES) U 0001307

(51) Int. Cl. B32B 3/06

(52) U.S. Cl. 428/100; 428/99

(57) ABSTRACT

Improved tablecloth and device for fixing the skirt of said tablecloth, said tablecloth comprising an independent skirt which can be detachably held to the board of the table by means which enable a variable distribution of the fixing points, and a cover which is placed on the surface of the table board and hanging sideways and hiding the edge of the board as well as the fixing points of the skirt. The device for fixing the skirt comprises a frame which is fixed to the lower part of the table board, and at a predetermined distance from the edge of said board, remaining slightly separated therefrom by discontinuous portions which can be integral with the frame or not. A variable number of C-shaped parts are placed on the frame which embrace it and are held by means of a narrowing section configured by its own branches, thereby enabling the lateral displacement along the frame. The portions are provided externally with Velcro-type bands to be fixed with their counter-parts which are sewn to the skirt, thereby making possible the displacement of the fixing points thus formed and a regular and esthetic distribution of the folds.

### OBJECT OF THE INVENTION

This invention refers to an improved tablecloth and tablecloth skirt attachment device. This tablecloth fits tables of different sizes and shapes due to its being fitted with a separate skirt. This skirt is attached by means of the device comprised within this invention.

### ANTECEDENTS OF THE INVENTION

At present, due to tables of different sizes existing, it is necessary, if one wishes to achieve a suitable aesthetic appearance, to avail of different tablecloths of different sizes for each table shape and size.

This is usually a problem for companies including those in the hotelkeeping and restaurant business, given that it forces them to have different tablecloths depending upon the different sizes of tables, with the added problem, in the case of large-sized tables, of the tablecloth losing shape after several washings due to its shrinking more along one grain of the fabric, this being an effect which can be heightened even further by industrial pressing procedures.

In addition to the above, in the event of burns and other damage to the tablecloth, it must be discarded completely, wasting many meters of fabric which might still be used.

Apart from the above, to dress tables of the type used at banquets, head tables at social functions, etc., tablecloths and skirts, whether or not integrated into said tablecloths, concealing the table frame and improving its aesthetic appearance are usually used.

In the case of skirts separate from the tablecloths, these skirts are held in place using strips of Velcro fastened to strips of this same material attached to the underside of the tabletop. The problem involved in this way of attaching the skirt is that it is difficult to arrange the points at which the skirt is attached so that they will be spaced evenly and allow the folds in the skirt to fall evenly all around.

### DESCRIPTION OF THE INVENTION

Due to its makeup and use, the improved tablecloth of the invention provides a optimum solution to the problems described above, given that it prevents the poor aesthetic appearance given by a tablecloth which has lost shape due to washing and/or industrial pressing, it affords the possibility of using one single size of tablecloth for different sizes of tables and, in the event of burns, etc. solely part of the tablecloth need be replaced, resulting in saving of a fabric being saved.

According to the invention, the tablecloth is comprised of two parts:

A piece to cover the tabletop, or cover, preferably made of cloth, the sole requirement with regard to size of which is that it completely cover said tabletop, hanging over the edges, as a result of which one single cover will serve to protect tabletops of different shapes and sizes, the edges hanging a shorter or longer distance off the floor.

A skirt, comprised of a preferably square piece of cloth which the attached to the tabletop mainly on the underside thereof using strips of Velcro, staples or any other means of varying the points of attachment, the free edge of which hangs down to the floor, covering the space exposed by the cover.

The skirt must be longer than the tabletop perimeter, and the points of attachment, as they are not fixed, afford the possibility of arranging the same individually on the tables of different shapes and sizes so that, with one single skirt of a certain length, tables of different perimeters can be dressed by changing the billow of the flares or folds evenly, the width of the skirt being constant, given that the distance from the tabletop to the floor is practically constant for any table.

The skirt attachment points and the edge of the tabletop are concealed behind the hanging portions of the cover, the table statically being the same as a table dressed with a full tablecloth and tablecloth cover.

Therefore, with a few different-sized tabletop covers and skirts, any table can be dressed, in addition to the fact that in the event that the tabletop cover is burned or irreparably stained, only the tabletop cover need be discarded, the skirt still being suitable for use.

The skirt is held in place preferably by means of a device comprised of a frame which is attached to the underside of the tabletop and which is equipped with some spacers so that, when the device is attached to the tabletop, it sets out slightly from it.

This frame is preferably similar in shape to the shape of the tabletop proper and is located a certain distance from the edge of the tabletop.

Some flat pieces, which are folded into a “C” shape, are inserted into the frame along the outside of the tablecloth, clamping it down, these pieces being fitted with a strip of Velcro on the part facing the outer edge of the table.

Each one of these pieces is secured to the frame by means of a piece which juts out from them by catching configured by the sides of the “C”.

Therefore, the pieces can be moved around the frame such that, when attaching the skirts, it will be easy, by moving them from one position to another. to arrange the points of attachment, providing an aesthetic effect of a regular arrangement thereof

### BRIEF DESCRIPTION OF THE FIGURES

FIG. 1 provides one view of the tablecloth of the invention.

FIG. 2 shows the placement of the skirt of the tablecloth of the invention.

FIG. 3 shows one section of the skirt attachment device.

FIG. 4 shows a perspective view of the skirt attachment device.

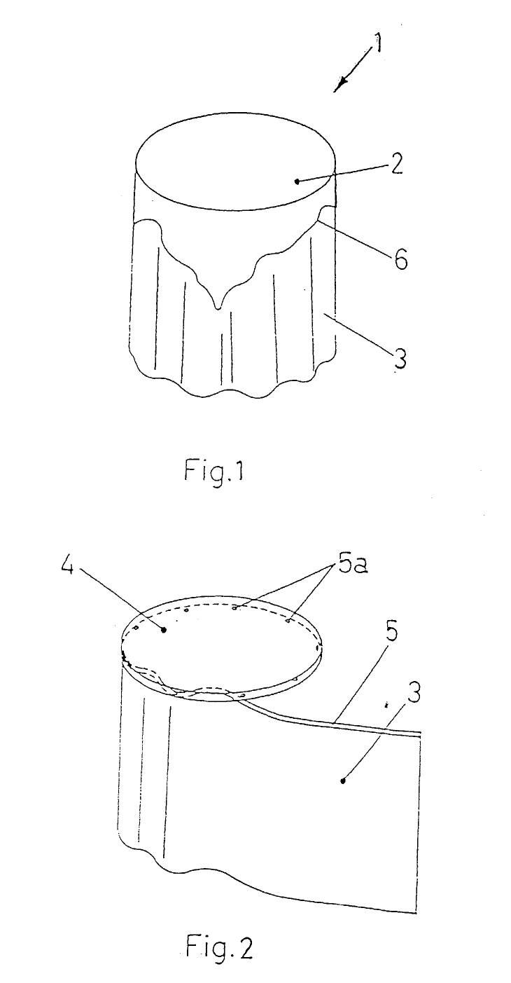

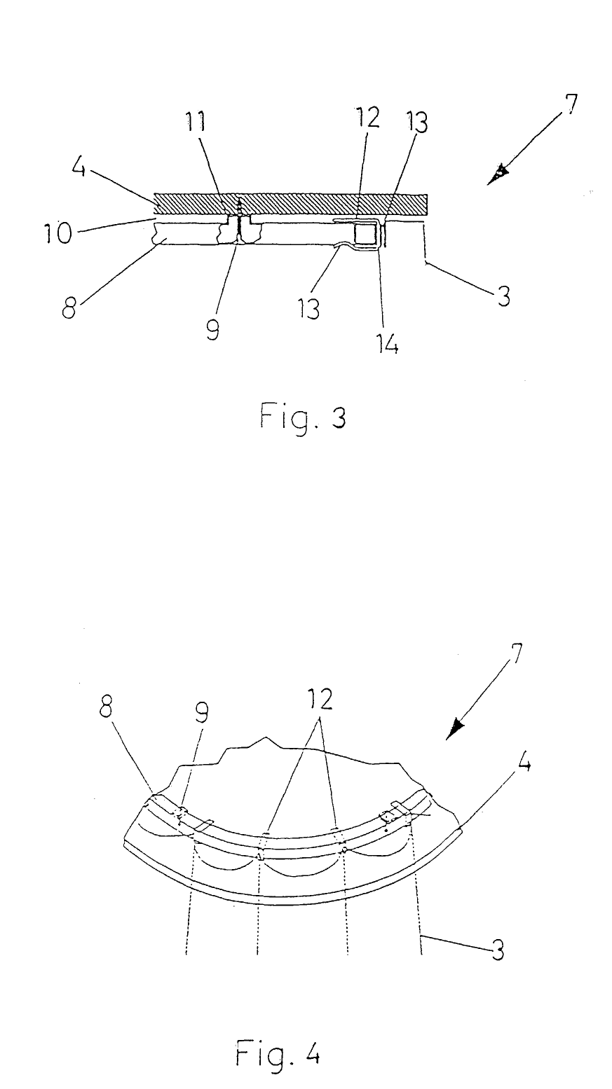

### DESCRIPTION OF ONE EMBODIMENT OF THE INVENTION

The tablecloth (1) of the invention is comprised of a cover (2) and a skirt (3).

The skirt is attached to the underside of the tabletop (4) by means of and end strip (5) of Velcro, which is affixed to opposite sides (5^{a}) of the same material which are stapled, glued, screwed, etc. into place on the underside of the tabletop so that on same size of skirt can be attached to tabletops of different sizes by selecting the points of attachment such that the folds will hang evenly, always under the condition that the skirt be of the same or of a longer length that the perimeter of the tabletop.

The cover is placed on the top side, covering the tabletop and hanging off the side concealing both the edge of the tabletop as well as the points at which the skirt is attached, the edges of the cover (6) being a shorter or longer distance from the floor depending upon the size of the tablecloth, which is thus ready for use.

To attach the skirt (3), a device (7) is preferably used, which is comprised of a frame (8) which is attached to the underside of the tabletop (4) by means of screws (9), a small space (10) being left between the two thanks to some pieces (11) jutting out from the frame holding the frame in place up against the tabletop.

One of the ends of a “C”-shaped piece (12) is inserted into one of the ends of said space, the other end of said piece having an overhanging piece (13) which helps to attach the piece to the frame, preventing it from accidentally slipping out, but allowing it to slide around the frame.

On the outside (14) of the piece (12), is a strip (13) of Velcro to which the opposite piece of the same material stitched to the skirt (3) is adhered.

Therefore, thanks to the moving of the pieces (12), the skirt attachment points can be arranged evenly, improving the aesthetics of the tablecloth.

1. Improved tablecloth and tablecloth skirt attachment device, said tablecloth being of the type consisting of a separate skirt which is detachably secured to the tabletop and a cover which is laid on top of the table; said tablecloth being distinct because the skirt is detachably secured to the underside of the tabletop by way of means affording the possibility of changing the arrangement of the attachment points, whilst the cover which is laid on top of the tabletop hanging over the side concealing the edge of the tabletop as well as the skirt attachment points.

2. Tablecloth as per claim 1, distinct due to the fact that the means of attaching the skirt consist of a strip of Velcro placed along the upper edge of the same for attaching opposite pieces of Velcro arranged on the underside of the tabletop.

3. Device as per claim 1, distinct due to its consisting of a frame which is attached to the underside of the tabletop at certain distance from the tabletop edge, being spaced slightly from the same by means of some discontinuous pieces which may or may not be part of the frame. A variable number of “C”-shaped pieces are attached to the frame, clamped to it and held in place by means of the narrowing of the opening configured by its sides proper, affording the possibility of sliding all the way around the frame. The outside of the “C”-shaped pieces are fitted with strips of Velcro to which the opposite Velcro is attached by being stitched to the skirt, the attachment points thus provided affording the possibility of arranging the folds evenly and aesthetically.
